(19) United States
(12) Patent Application Publication
(10) Pub. No.: US 2023/0239452 A1
(43) Pub. Date: Jul. 27, 2023

(54) COLOR STEREO CAMERA SYSTEMS WITH GLOBAL SHUTTER SYNCHRONIZATION

(71) Applicant: Advanced Farm Technologies, Inc., Davis, CA (US)

(72) Inventor: Carl Allendorph, San Diego, CA (US)

(21) Appl. No.: 18/007,620

(22) PCT Filed: May 28, 2021
(86) PCT No.: PCT/US2021/034833

§ 371 Date: Dec. 1, 2022

Related U.S. Application Data
(60) Provisional application No. 63/034,566, filed on Jun. 4, 2020.

(51) Int. Cl. H04N 13/167; H04N 13/194; H04N 13/239; H04N 13/257; H04N 13/271

(52) U.S. Cl. CPC H04N 13/167; H04N 13/194; H04N 13/239; H04N 13/257; H04N 13/271

(57) ABSTRACT

Stereo imaging systems and devices are disclosed. A stereo imaging system can include one or more stereo imaging modules and an image processing module connected to the one more stereo imaging modules by a coaxial cable that carries two-way communication signals and transfers electrical power from the image processing module to the stereo imaging modules. The stereo imaging modules each include a plurality of image sensors positioned to capture images of at least partially overlapping fields of view, and processing circuitry configured to transmit the captured images to the stereo imaging module via the coaxial cable. The processing module includes processing circuitry configured to receive and process the captured images, and power circuitry configured to provide electrical power to the stereo imaging module via the coaxial cable. The plurality of image sensors may be color image sensors configured to collect color images for stereo image processing.

### CROSS-REFERENCE TO RELATED APPLICATIONS

This application claims the benefit of U.S. Provisional Application Ser. No. 63/034,566, filed Jun. 4, 2020, titled COLOR STEREO CAMERA SYSTEMS WITH GLOBAL SHUTTER SYNCHRONIZATION, which is hereby incorporated by reference in its entirety and for all purposes.

### FIELD

The present disclosure relates to camera systems, and more particularly to robust stereo camera systems.

### BACKGROUND

Stereo imaging systems, including two or more image capture devices, are useful in a variety of applications. For example, stereo imaging systems may be used in computer stereo vision applications, in the generation of stereoscopic images or video, or in other applications in which it may be useful to capture three-dimensional information in one or more images. In some implementations, it may be desirable to implement stereo imaging within automated or semi-automated systems, such as robots and the like, for monitoring and/or control processes. However, existing stereo camera systems have a number of deficiencies, especially when used in conjunction with devices that experience frequent motion. For example, some stereo cameras are not structurally robust enough to resist relative motion between the imagers, resulting in unreliable three-dimensional information. Existing stereo cameras often only provide greyscale imaging capability, or rely on a third imager to provide color imaging capability. Moreover, shutter synchronization in existing stereo cameras is often not sufficiently reliable for use in implementations with frequent motion.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In a first aspect, a stereo imaging system includes a stereo imaging module and a processing module. The stereo imaging module includes a plurality of image sensors positioned to capture images of at least partially overlapping fields of view, and processing circuitry configured to transmit the captured images via a coaxial cable connected to the stereo imaging module. The processing module is configured to receive the captured images from the stereo imaging module via the coaxial cable. The processing module includes processing circuitry configured to receive and process the captured images, and power circuitry configured to provide electrical power to the stereo imaging module via the coaxial cable.

In some embodiments, the plurality of image sensors are color image sensors. In some embodiments, the image processing module is configured to generate a depth mapping at least a portion of the partially overlapping fields of view based at least in part on color images captured by the color image sensors. In some embodiments, the image processing module is further configured to generate one or more greyscale images based on the color images, the depth mapping generated based at least in part on the one or more greyscale images.

In some embodiments, the processing circuitry of the processing module is further configured to transmit to the stereo imaging module, via the coaxial cable, a timing signal that causes the plurality of image sensors to capture images simultaneously. In some embodiments, the timing signal is a repetitive time-varying signal that causes the plurality of image sensors to capture a series of time-synchronized images. In some embodiments, the stereo imaging system further includes at least a second stereo imaging module connected to the processing module by a second coaxial cable, the second stereo imaging module including a second plurality of image sensors, wherein the processing circuitry of the processing module is configured to simultaneously transmit the timing signal via the coaxial cable and the second coaxial cable such that the plurality of image sensors and the second plurality of images sensors capture images simultaneously.

In some embodiments, the stereo imaging module is mounted to a mechanical component configured to move relative to the processing module, and wherein a stereo imaging module end of the coaxial cable is coupled to a coaxial connector fixed to the mechanical component, the coaxial connector flexibly connected to the processing circuitry of the stereo imaging module such that forces applied from the coaxial cable to the coaxial connector are not transferred to the processing circuitry of the stereo imaging module or to the plurality of image sensors. In some embodiments, the mechanical component includes an end effector of a picking device. In some embodiments, the processing module is connected by a second coaxial cable to a second stereo imaging module. In some embodiments, the second stereo imaging module is mounted to a second end effector or a stationary component of the picking device. In some embodiments, the picking device is a mobile picking device, and wherein the second stereo imaging module is fixed relative to a chassis of the mobile picking device.

In some embodiments, the stereo imaging module further includes a temperature sensor configured to determine a temperature of the stereo imaging module, and a heating element in communication with the temperature sensor and configured to activate when the temperature sensor detects a temperature lower than a predetermined threshold.

In some embodiments, the plurality of image sensors are spaced apart by a baseline distance of at least 5 mm and not greater than 50 mm. In some embodiments, the plurality of image sensors are spaced apart by a baseline distance of at least 10 mm and not greater than 40 mm, In some embodiments, the plurality of image sensors are spaced apart by a baseline distance of at least 15 mm and not greater than 30 mm, In some embodiments, the plurality of image sensors are spaced apart by a baseline distance of at least 20 mm and not greater than 25 mm.

in some embodiments, the processing circuitry of the stereo imaging module includes a serializer configured to transmit the captured images to a deserializer of the image processing module via the coaxial cable.

In some embodiments, the processing circuitry of the stereo imaging module is further configured to combine pairs of individual images captured at the same time by the plurality of image sensors prior to transmission to the image processing module.

In some embodiments, the stereo imaging module is mounted to an end effector of a picking device, and wherein the plurality of image sensors are spaced apart by a baseline distance of at least 20 mm and not greater than 25 mm.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 schematically illustrates components of an example stereo imaging system.

FIG. 2 schematically illustrates components of an example stereo imaging module of a stereo imaging system.

FIG. 3 schematically illustrates components of an example image processing module of a stereo imaging system.

FIGS. 4A-4D illustrate an example implementation of a stereo imaging module in accordance with the present technology.

FIG. 5 illustrates an example stereo imaging module including a motion and force resistant coaxial connector.

FIGS. 6 and 7 illustrate example robot and harvester implementations of stereo imaging systems in accordance with the present technology.

FIGS. 8A-8C illustrate an example implementation of a stereo imaging module in conjunction with an end effector, in accordance with the present technology.

### DETAILED DESCRIPTION

Embodiments of the present technology provide stereo imaging systems and devices that provide high quality stereo imaging systems. Certain embodiments provide stereo imaging systems with improved synchronization, color processing, robust construction, advantageous distribution of components, light weight, and/or simplified construction. Some stereo imaging systems of the present technology include two or more components such as a stereo imaging module and an image processing module connected by a cable. The cable may be connected to the stereo imaging module at a force-resistant coupling as described herein which prevents the transfer of loads from the cable to the stereo imaging module components. Throughout the following description, various embodiments will be described with reference to the example implementation of robotics. However, it will be understood that any of the systems, devices, or methods described herein may equally be applied to any other application where stereo imaging is desirable.

Existing stereo cameras typically have two lenses and are capable of capturing three-dimensional information. However, existing stereo cameras often are not structurally robust enough to resist relative motion between the imagers, resulting in unreliable three-dimensional information, Existing stereo cameras often only provide greyscale imaging capability, or rely on a third imager to provide color imaging capability.

Moreover, shutter synchronization in existing stereo cameras is often not sufficiently reliable for use in implementations with frequent motion. Existing stereo cameras typically operate in a master-slave synchronization arrangement, in which one of the two imagers operates as a master and the other imager operates in a slave mode. The master imager generates a timing signal intended to cause the slave imager to capture an image at approximately the same time as the master imager captures an image, such that depth mapping or other processing based on multi-image registration can be performed. However, existing master-slave synchronization techniques may be imprecise. In addition, existing synchronization techniques do not allow for the synchronization of multiple stereo cameras. As will be discussed in greater detail, the stereo imaging systems of the present technology provide improvements that address these shortcomings of existing stereo camera technology.

One particular implementation, for which the stereo imaging systems of the present technology may be particularly advantageous, is the field of picking devices such as autonomous assembly line robots or agricultural harvesters, and the like. In many implementations, such devices may use eye-in-hand configurations in which one or more cameras are mounted on an end effector or other moving component of the picking device. Some agricultural implementations may require a relatively high acceleration (e.g., in the range of 3 g-5 g or more), such as to separate a berry or other fruit from a stem. Such rapid motion and/or acceleration may cause problems when existing stereo cameras are used in eye-in-hand configurations. For example, motion or acceleration of an end effector may cause the imagers of a stereo camera to move relative to each other, such as by bending or twisting of the stereo camera housing. If the stereo camera is connected to other systems by a cable connector, the cable connector may exert a force on the stereo camera or components thereof, which may cause damage. Accordingly, the stereo imaging systems of the present technology may be suitable for withstanding such motion and acceleration as may be experienced in high-motion and high-acceleration applications.

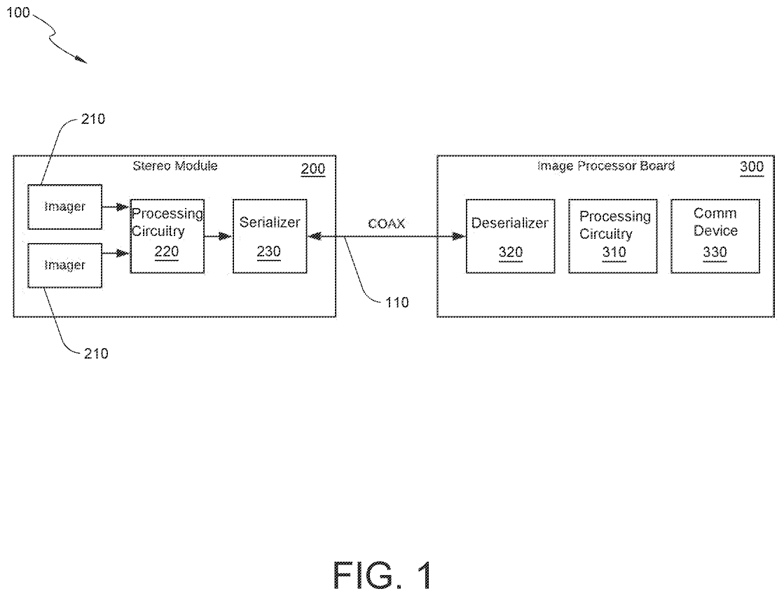

Referring now to the drawings, FIG. 1 schematically illustrates components of an example stereo imaging system 100, The stereo imaging system 100 includes a stereo imaging module 200 and an image processing module 300. The stereo imaging module 200 and the image processing module 300 are electrically connected by a cable 110, such as a coaxial cable or other conductive connector. As will be described in greater detail, the stereo imaging module 200 and the image processing module 300 may be discrete components disposed in different locations and/or at least partially contained within separate housings. In some embodiments, a stereo imaging system 100 may include two or more stereo imaging modules 200 connected to an individual image processing module 300, may include two or more image processing modules 300 connected to an individual stereo imaging module 200, and/or may include a plurality of stereo imaging modules 200 and image processing modules 300. Accordingly, the stereo imaging module 200 and/or the image processing module 300 may be configured to individually receive a plurality of cables 110 to enable such combinations.

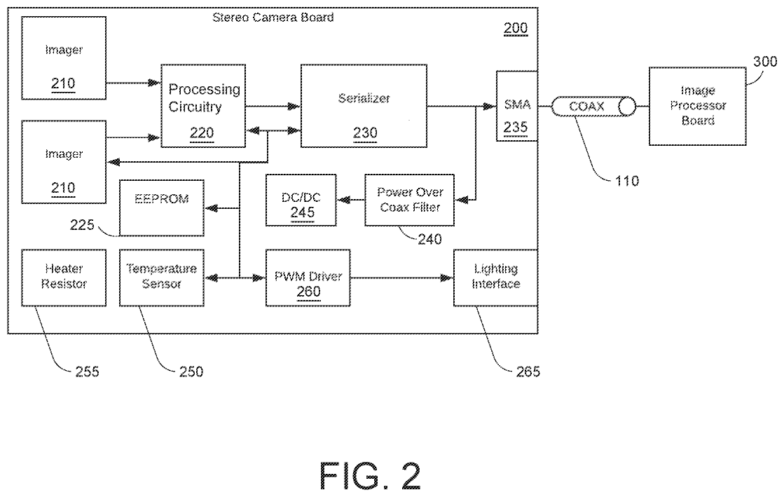

The stereo imaging module 200 includes two or more imagers 210 and processing circuitry 220 in communication with the imagers 210. In some embodiments, such as embodiments in which the cable 110 is a coaxial cable, the stereo imaging module 200 further includes a serializer 230 that serializes image data for transmission via the cable 110 to the image processing module 300. The imagers 210 may be any suitable type of camera, image sensor, or the like, and in some cases may advantageously be color imagers. In some embodiments, the imagers 210 further include associated components such as lenses or other optical components, as well as image sensors and readout electronics that generate digital image data based on light received at the imagers 210. The processing circuitry 220 may include any one or more suitable processing components, such as one or more controllers, field programmable gate arrays (FPGA), memory devices such as electrically erasable programmable read-only memory (EEPROM), or the like. In operation, the imagers 210 may capture images simultaneously or near-simultaneously, and may send the captured images to the processing circuitry 220 in the form of digital image data. The processing circuitry 220 may perform some initial processing and send the processed image data to the serializer 230, which transmits the image data to the image processing module 300 via the cable 110. The stereo imaging module 200 will be described in greater detail with reference to FIGS. 2 and 4A-5.

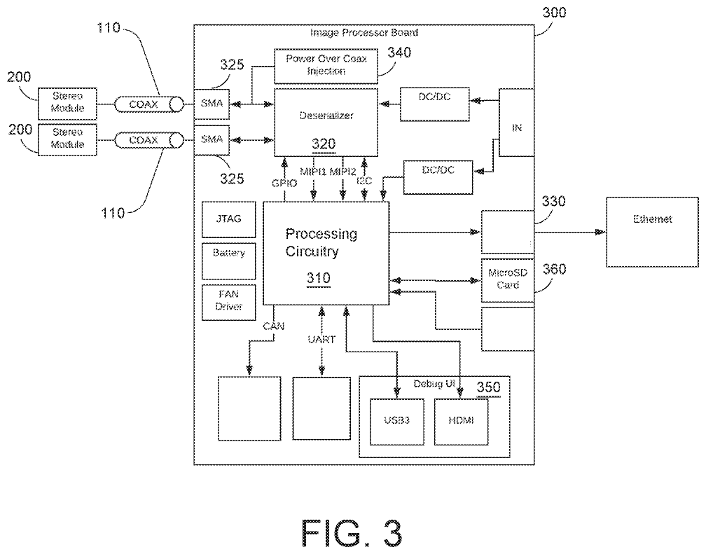

The image processing module 300 includes processing circuitry 310 configured to perform further image processing on the image data received from the stereo imaging module 200 or from a plurality of stereo imaging modules 200. In embodiments in which the stereo imaging module 200 includes a serializer 230, the image processing module 300 can further include a deserializer 320 which receives the serialized data from the cable 110 and converts the serial data back into a suitable format for the processing circuitry 310. A communication device 330 may communicate with one or more other components, such as by Ethernet or any other suitable computer networking technology. The image processing module 300 will be described in greater detail with reference to FIG. 3.

FIG. 2 schematically illustrates components of an example stereo imaging module 200 of a stereo imaging system, such as the stereo imaging module 200 of the stereo imaging system 100 illustrated in FIG. 1, The stereo imaging module 200 may be implemented in conjunction with one or more image processing modules 300 as illustrated in FIG. 3. It will be understood that various embodiments of the present technology may equally include stereo imaging modules 200 having more or fewer components, or different components than those illustrated in FIG. 2, without departing from the spirit or scope of the present disclosure.

The stereo imaging module 200 includes two or more imagers 210 in communication with processing circuitry 220 and a serializer 230, as described with reference to FIG. 1. The stereo imaging module 200 may further include a memory device 225, power circuitry such as a filter and/or DC-to-DC converter 245, temperature control components such as a temperature sensor and/or a heating element 255, and/or lighting components such as a lighting controller 260 and/or a lighting interface 265. A connector 235, such as a SubMiniature version A (SMA) or other coaxial connector (e.g., SMB, SMC, or other RF connector type), is provided for connecting the stereo imaging module 200 to the cable 110.

In order to implement stereo imaging, the imagers 210 preferably include two imagers 210 that have at least partially overlapping fields of view. In contrast to existing stereo imaging systems, which typically perform stereo imaging using greyscale imagers and rely on a third imager to provide color, the imagers 210 may be color imagers capable of capturing color images. Using color images for stereo imaging may be especially advantageous by reducing the amount of processing required for stereo imaging in implementations requiring color detection, such as for berry harvesting applications. In such applications, the images captured by the imagers 210 may be used immediately for the detection of targets based on color, without requiring the additional processing steps of registering a separate color image to the greyscale images, This immediate use of images for target detection based on color may be particularly advantageous where the picking device has a limited window of time and/or space to recognize and/or pick a target (e.g., targets moving past a stationary picking device on a conveyor, a harvester moving over a bed of stationary targets to be harvested, etc.). In such implementations, any improvement in image processing speed may significantly enhance operational efficiency.

Each of the imagers 210 may he triggered to capture an image by a timing signal received from an external source. In some embodiments, the timing signal may be, for example, a control signal that causes an imager 210 to capture an image when the signal is received, or a clock signal that the imager 210 may use to capture one or more images at a predetermined time or interval. In one example, the timing signal may be a repetitive time-varying signal such as a clock signal, which causes the imagers 210 to capture a series of time-synchronized images and/or video. In some embodiments, the imagers 210 may advantageously be controlled in accordance with a synchronized “global shutter” scheme such that the imagers 210 capture images at exactly the same time, improving the accuracy of stereo image processing. In some embodiments, a timing signal may be generated at the stereo imaging module 200 to synchronize the imagers 210. In other embodiments, the timing signal may be generated external to the stereo imaging module, such as at the image processing module 300 or other control module, and sent to the stereo imaging module 200 via the cable 110.

The processing circuitry 220 receives images captured by the imagers 210 and may perform one or more image signal processing operations before the captured images are sent to the image processing module 300. In some embodiments, the processing circuitry 220 is programmed to receive two simultaneously captured images from the imagers 210 (e.g., by receiving one image from each imager 210) and to combine the two simultaneous images prior to transmission. Combining pairs of images may have a variety of advantages, for example, by improving transmission efficiency and/or by simplifying image registration and/or other aspects of image processing to be performed at the image processing module 300.

The stereo imaging module 200 may receive electrical power from the image processing module 300 via the cable 110. In the case of a coaxial cable 110, electrical power for the stereo imaging module 200 may be provided through the same central conductor of the coaxial cable 110 that is used for transmission of signals between the stereo imaging module 200 and the image processing module 300. For example, electrical power may be sent through the coaxial cable 110 as a low-frequency signal, while communications between the stereo imaging module 200 and the image processing module 300 may be sent in a high-frequency domain such that the power transmission does not interfere with communications.

Electrical power may be transmitted at a relatively high voltage (e.g., 24 volts) and low current. Thus, the stereo imaging module 200 can include a power signal filter 240 and a converter 245 which operate to select the low-frequency power signal and decrease the voltage to a suitable level for use by the components of the stereo imaging module.

In some applications, low temperatures may interfere with the operation of imagers 210 by causing condensation of water from the atmosphere on exterior or interior surfaces of lenses or other components of the stereo imaging module 200. Additionally, temperature changes can cause material expansion and/or contraction that may result in deformation or other changes in the mounting and optics of the imagers, potentially introducing error into operations performed based on the acquired stereo images. Thus, it may be desirable to keep the stereo imaging module 200 above a low threshold temperature and/or at a relatively constant temperature. Accordingly, in some embodiments, the stereo imaging module 200 includes a temperature sensor 250 and a heating element 255, such as a resistive heater. Control circuitry in communication with the temperature sensor 250 and the heating element 255 can cause activation of the heating element 255 when a temperature below a set low threshold is detected at the temperature sensor 250. The low threshold may be, for example, a predetermined constant threshold, an adjustable threshold, or a threshold determined based on atmospheric conditions such as a reported dew point or other known atmospheric conditions, associated with condensation of water.

FIG. 3 schematically illustrates components of an example image processing module 300 of a stereo imaging system, such as the image processing module 300 of the stereo imaging system 100 illustrated in FIG. 1. The image processing module 300 may be implemented in conjunction with one or more stereo imaging modules 200 of FIG. 2. It will be understood that various embodiments of the present technology may equally include image processing modules 300 having more or fewer components, or different components than those illustrated in FIG. 3, without departing from the spirit or scope of the present disclosure.

The image processing module 300 includes processing circuitry 310, a deserializer 320, and a communication device 330 such as an Ethernet port or the like, as described with reference to FIG. 1. The image processing module 300 may further include a power injector 340, and one or more interfaces such as a user interface 350 and/or a memory device port 360.

The processing circuitry 310 may include any one or more computer processing devices such as a CPU, controller, system on module (SoM) or system on chip (SoC) device, or other processing component. Example functions of the processing circuitry 310 may include, but are not limited to, control of the image processing module 300, processing and/or analysis of images received from the stereo imaging modules 200, and control functions related to the stereo imaging modules 200, such as generation and/or control of timing signals to the imagers of the stereo imaging modules 200. In some embodiments,

[symbol]

The deserializer 320 receives the serialized data transmitted by the serializer 230 of a stereo imaging module 200, and converts the serial data back into a suitable format for the processing circuitry 310. As shown in FIG. 3, the image processing module 300 may include two or more connectors 325, such that the image processing module 300 may be used in conjunction with a plurality of stereo cameras simultaneously. In such embodiments, a single deserializer 320 may be in communication with all of the connectors 325. In other embodiments, the image processing module 300 may include two or more deserializers.

In some embodiments, the deserializer 320 may also transmit data to the stereo imaging modules 200, such as to implement a global shutter timing across multiple imagers. In such embodiments, the deserializer 320 may send a synchronized timing signal to all of the stereo imaging modules 200 via the cables 110, For example, in some embodiments the deserializer 320 may generate imager control signals, such as shutter timing signals, a clock signal, or the like, which may be used by the imagers 210 of the individual stereo imaging modules 200. In another example, the timing signals may be generated at the processing circuitry 310. Accordingly, the present technology provides an improved global shutter functionality that can be used to capture highly synchronized images both among imagers of an individual stereo imaging module 200 and/or across a plurality of stereo imaging modules 200 that are connected to the image processing module 300.

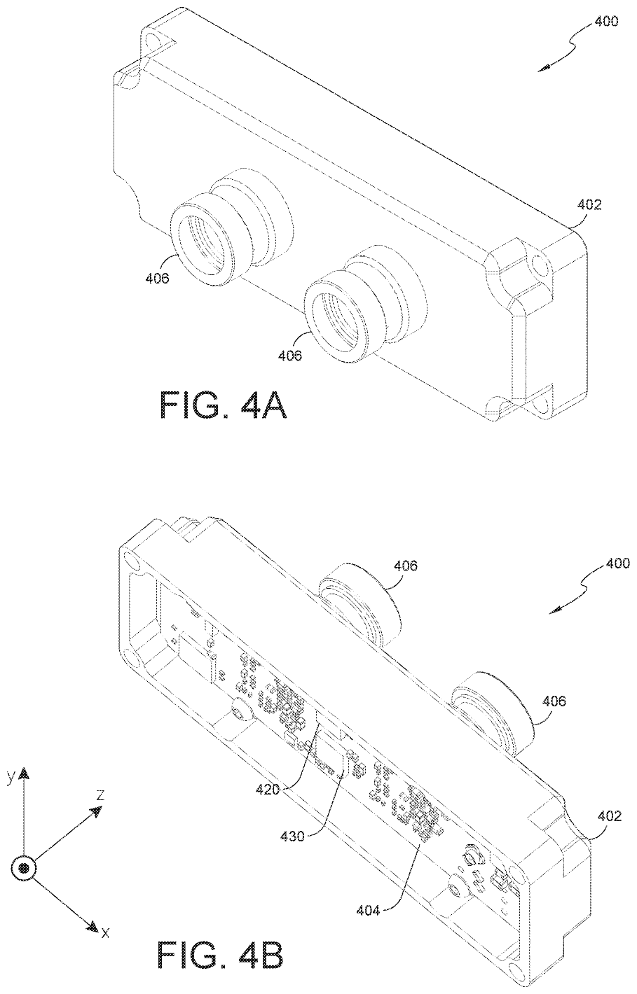

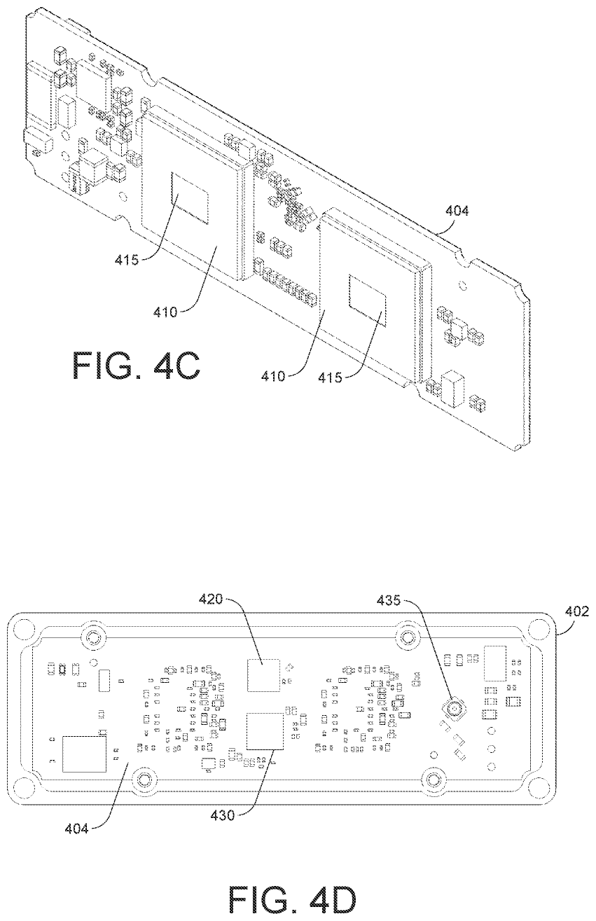

FIGS. 4A-4D illustrate an example implementation of a stereo imaging module 400 in accordance with the present technology, FIGS. 4A and 4B are front and rear perspective views, respectively, of the stereo imaging module 400. FIG. 4C is a front perspective view in which the housing is hidden, illustrating internal components of the stereo imaging module 400. FIG. 4D is a rear elevation view of the stereo imaging module 400. The stereo imaging module 400 may be an implementation of the stereo imaging module 200 schematically illustrated in FIGS. 1-3. It will be understood that stereo imaging module 400 is one non-limiting example of the stereo imaging module 200, and other examples can be suitably implemented in accordance with the present technology. The stereo imaging module 400 may be implemented in conjunction with any of the image processing modules 300 and/or stereo imaging systems 100 disclosed herein.

The stereo imaging module 400 includes a housing 402 at least partially surrounding a stereo imaging module board 404. The imagers 410, processing circuitry 420, serializer 430, and connector 435 can be coupled to the stereo imaging module board 404. Lenses 406 are coupled to, or integrally formed with, the housing 402 and are located in a spaced configuration on a front of the housing 402 so as to direct light from the environment to photodetectors 415 of the imagers 410. In some embodiments, the lenses 406, the housing 402, and a component to which the housing 402 is coupled, may form a complete housing that is sufficiently sealed against environmental contaminants so as to prevent dust or other particulate matter from intruding and damaging optical or electrical components of the stereo imaging module 400. Environmentally sealed embodiments may be especially advantageous where the stereo imaging module 400 is implemented in conjunction with agricultural harvesters where dirt and dust may be kicked up by harvesting operations.

The spacing of the lenses 406, and the corresponding spacing of the photodetectors 415 of the imagers 410, define a center-to-center baseline distance of the stereo imaging module 400. In some embodiments, the baseline distance of the stereo imaging module 400 may be, for example, between 5 mm and 50 mm, between 10 mm and 40 mm, between 15 mm and 30 mm, between 20 mm and 2 5mm, or any other suitable range for the intended application of the stereo imaging module 400. In one particular implementation, a baseline distance of at least 20 mm and not more than 25 mm may be especially advantageous for eye-in-hand applications in which the stereo imaging module 400 is mounted to an end effector of a harvesting robot. Specifically, a baseline distance of 20 mm-25 mm has been found to be desirable for close viewing of objects (e.g., at a distance of approximately 150 min to 500 mm from the stereo imaging module 400), while also avoiding occlusion of the imagers 410 and/or lenses 406 by leaves or other parts of plants such as strawberry plants or other crops. In some cases, even if a portion of the field of view of one of the imagers 410 is occluded by a plant, the occluded region may be imaged by the other imager 410 of the stereo imaging module 400 for target detection, even if the occlusion prevents reliable depth mapping of that portion of the field of view.

The housing 402 may include a single integrally formed piece of a suitably rigid material, such as a hard plastic, a metal, wood, or the like. Preferably, the housing 402 is sufficiently rigid as to resist bending or twisting even at accelerations of up to 3 g, 5 g, 10 g, or more, depending on the intended application, as such bending or twisting may result in slight changes in baseline distance or the relative angles of the imagers 410, which may detrimentally affect stereo imaging quality. For example, a stereo imaging module 400 for use in an autonomous agricultural harvester may have a hard plastic housing 402 of sufficient thickness to prevent relative motion of the imagers 410 at acceleration forces of 5 g or more.

Moreover, the stereo imaging module 400 may be advantageously small and/or lightweight so as to avoid interfering with or inhibiting such motion or acceleration as may be desired for the mounting location of the stereo imaging module 400. For example, where the stereo imaging module 400 is mounted in conjunction with an end effector manipulated by a robot, it may be desirable for the stereo imaging module 400 to be small enough so as to avoid interfering with the motion of the end effector or the robot It may further be desirable for the stereo imaging module 400 to be light enough so as not to substantially increase the amount of force necessary to achieve an intended motion of the end effector.

In some embodiments, the stereo imaging module 400 has a total weight of less than 500 g, less than 200 g, less than 100 g, etc. In some embodiments, the stereo imaging module 400 has a total length (along the x-direction in FIG. 4B) of less than 100 mm, a total width (along the y-direction in FIG. 4B) of less than 30 mm, a housing thickness (along the z-direction in FIG. 4B) of less than 20 mm, and/or a total thickness of less than 30 min including the lenses 406. In one example, the stereo imaging module 400 has a weight of approximately 75 g (e.g., between 74 g and 76 g), a length of approximately 77 mm (e.g., between 76 mm and 78 mm), a width of approximately 27 mm (e.g., between 26 min and 28 mm), a housing thickness of approximately 13 min (e.g., between 12 min and 14 mm), and a total thickness of approximately 27 mm (e.g., between 26 mm and 28 mm). It will be understood that these are example weights and dimensions, and other examples can be suitably implemented in accordance with the present technology.

In addition to bending or twisting forces, the coaxial cable connection also presents a risk for misalignment or damage to the stereo imaging module 400 and the components thereof. For example, because the coaxial cable 110 (FIGS. 1-3) is securely attached to the stereo imaging module 400, significant forces may be exerted at the connector 435 (e.g., if the stereo imaging module 400 is move to an extreme position far from the image processing module 300 such that the cable 110 becomes taut, and/or if the cable 110 becomes tangled or obstructed by one or more other objects).

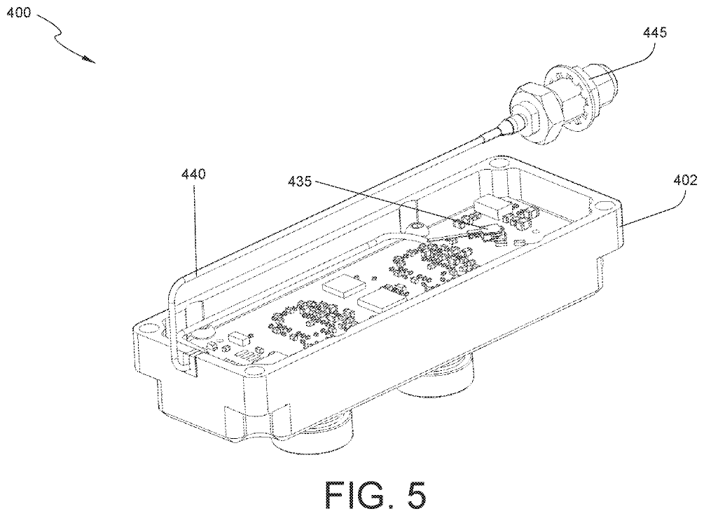

Accordingly, FIG. 5 illustrates an example motion and force resistant coaxial connector arrangement that can be implemented in accordance with any of the embodiments disclosed herein. The motion and force resistant connector arrangement includes an intermediate cable 440 that connects the connector 435 with a second connector 445. The second connector 445 is a suitable connector for receiving the cable 110 (FIGS. 1-3) that connects the stereo imaging module 400 to an image processing module 300 (FIGS. 1-3). In this configuration, the housing 402 of the stereo imaging module 400 can be mounted to a mechanical component that is movable relative to the image processing module 300 (for example, a component of a robot or end effector of a picking device or harvester). The second connector 445 may be mounted to a portion of the same mechanical component or another component rigidly fixed thereto, such that the second connector 445 is fixed relative to the housing 402 and the stereo imaging module board 404. Thus, any motion or force imparted by the cable 110 connected to the second connector 445 will be transferred primarily to the mechanical component to which the stereo imaging module 400 and the second connector 445 are mounted. The motion or force accordingly will not be transferred to the intermediate cable 440 or the connector 435, such that damage to or misalignment of the internal components of the stereo imaging module 400 is avoided.

### Example Applications of Stereo Imaging Systems According to the Present Disclosure

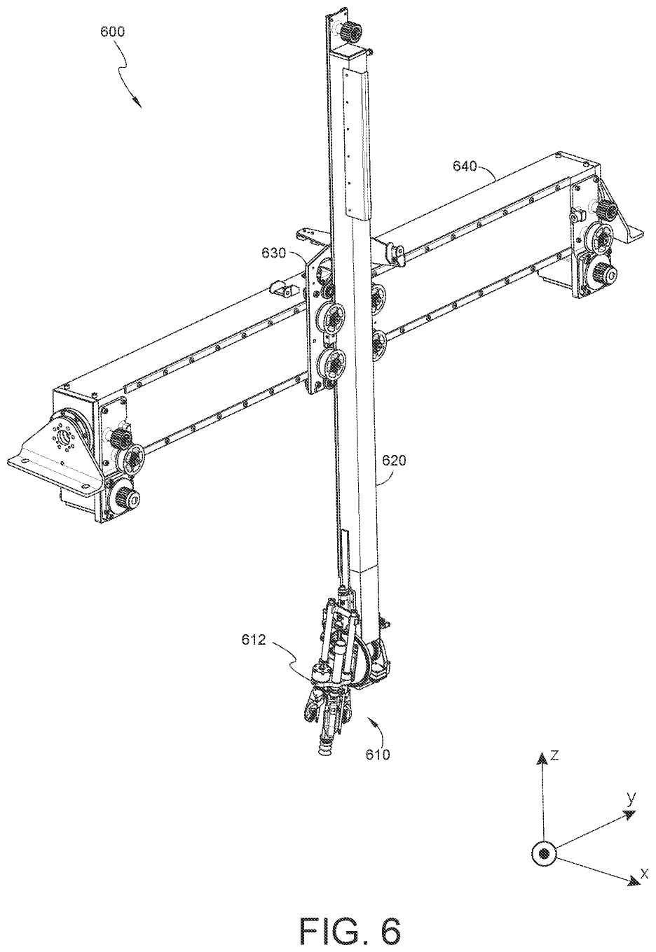

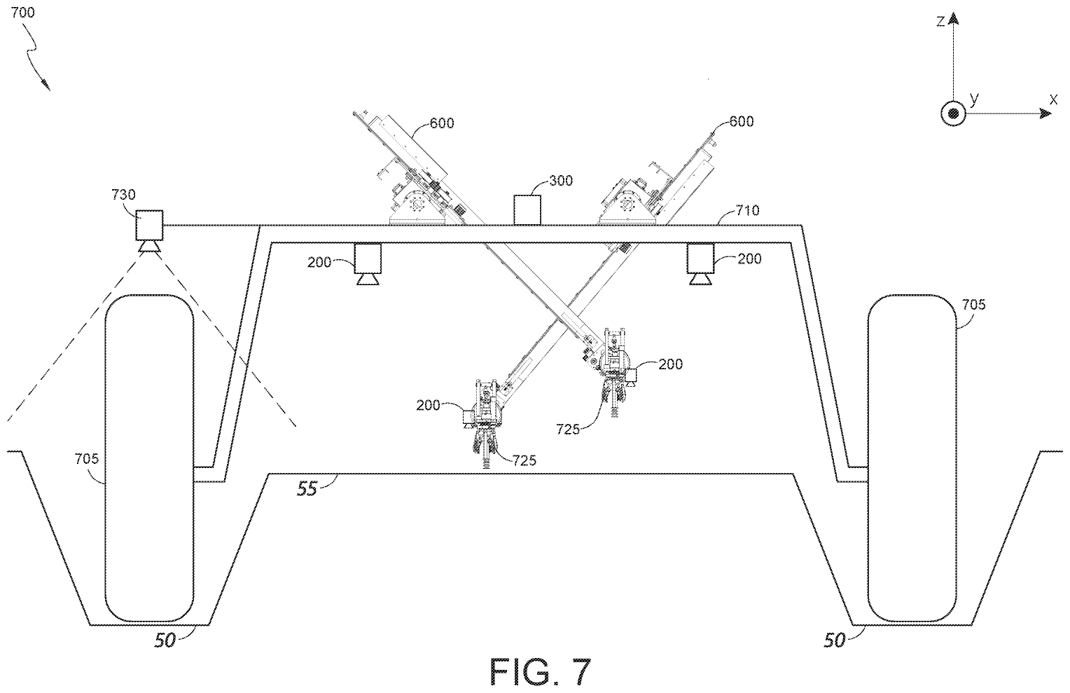

As discussed previously, the stereo imaging systems of the present technology may be advantageously suitable for use in conjunction with autonomous devices such as harvesters and other picking devices or other robotic applications. FIGS. 6 and 7 illustrate example systems in which the presently disclosed stereo imaging systems may be implemented.

FIG. 6 illustrates an example robot 600 that may be used in conjunction with the stereo imaging systems of the present technology. The example robot 600 is illustrated as a t-type robot 600 configured to support an end effector 610 and to move the end effector 610 as desired within a harvester work cell or other picking area. The robot 600 generally includes a radial member 620, a carriage 630, and a longitudinal member 640. The longitudinal member 640 may be a gantry or other generally linear component, and may be mounted to a harvester, such as the harvester 700 of FIG. 7.

FIG. 7 is a cross-sectional view schematically illustrating components of an example harvester 700 according to the present disclosure including two robots consistent with the robot 600 of FIG. 6. The harvester 700 includes a plurality of wheels 705 supporting a platform 710. The harvester 700 is configured to travel within an agricultural field. Accordingly, the platform 710 is positioned relative to the wheels 705 such that the platform 710 is supported above a row 55 while the wheels 705 travel along the bottom of furrows 50 surrounding the row 55.

In various embodiments, the stereo imaging modules 200 and image processing modules 300 disclosed herein may be mounted at various locations on or around the robots 600 and/or the harvester 700. For example, in an eye-in-hand configuration, each robot 600 may have a stereo imaging module 200 disposed thereon, The stereo imaging module 200 may be mounted to the end effector 610, a radial member 620, a carriage 630, or a longitudinal member 640 of a robot. In addition, one or more stereo imaging modules 200 may be a global camera mounted to the platform 710 of the harvester 700. In one particular configuration, as shown in FIG. 7, the harvester 700 may include two stereo imaging modules 200 for each robot 600, including one stereo imaging module 200 mounted to the robot 600 or end effector 610, and a second stereo imaging module 200 mounted to the platform 710 to provide an overhead view of the picking area that is stationary relative to the chassis of the harvester 700. In some embodiments, each robot may have its own stereo imaging system including a robot-specific image processing module 300. In other embodiments, an image processing module 300 may be connected to more than two stereo imaging modules (e.g., the example configuration illustrated in FIG. 7 may include four total stereo imaging modules 200 and one image processing module 300). Other combinations are possible.

Referring again to FIG. 6, the robot 600 is configured to accommodate motion along and about several axes. For example, the longitudinal member 640 may be rotated about its longitudinal axis (parallel to the y-axis illustrated in FIG. 6). The carriage 630 may move linearly along the longitudinal member 640 in the y-direction. The radial member 620 may move linearly perpendicular to the y-axis, along a direction in the x-z plane dependent on the rotational orientation of the longitudinal member 640. Additionally, the end effector 610 may be rotatable relative to the radial member 620. Thus, the robot 600 is movable along a number of axes that could potentially cause stress or forces to act on the stereo imaging modules 200 mounted on the robot 600. Accordingly, the motion and force resistant coaxial connector arrangement discussed with reference to FIG. 5 may be desirable in these implementations. In one non-limiting embodiment, the stereo imaging modules 200 withstand more than 5 g acceleration on a continual basis when the harvester is operational over a period of one or more hours.

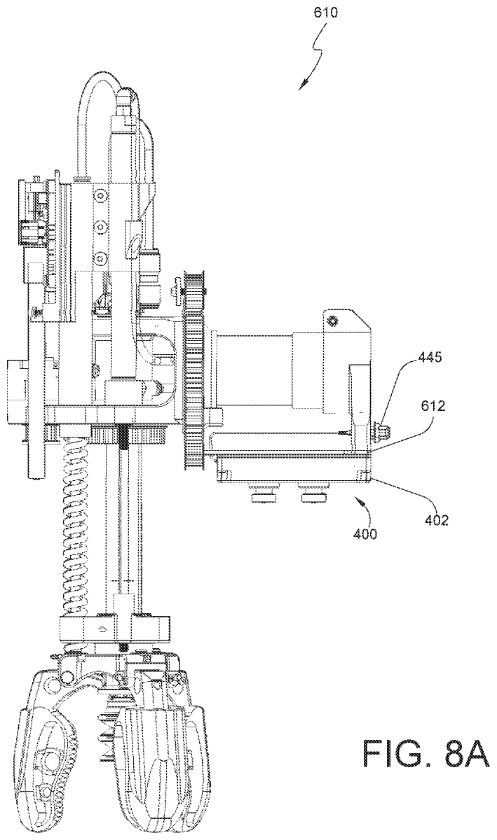

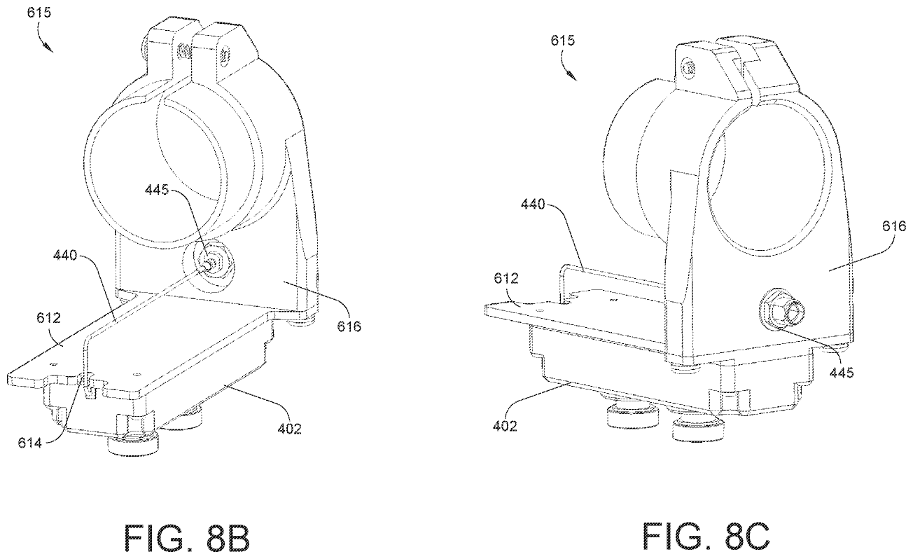

FIGS. 8A-8C illustrate one example implementation of a stereo imaging module 400 (FIGS. 4A-5) in conjunction with an end effector such as the end effector 610 illustrated in FIG. 6. FIG. 8A is a side view of the end effector 610; FIGS. 8B and 8C are perspective views of a baseplate 612 and an additional rigid component 615 to which the stereo imaging module 400 and second connector 445 are attached. As shown in FIGS. 8A-8C, the housing 402 of the stereo imaging module 400 is mounted to an underside of a substantially rigid, planar baseplate 612 of the end effector 610. The intermediate cable 440 passes through the baseplate 612 (e.g., around an edge or through a slot 614 or aperture) and connects to the second connector 445, which is rigidly mounted to a surface 616 of the component 615. In some embodiments, the second connector 445 may be connected directly to the top side of the baseplate 612, or to any other component proximate the stereo imaging module 400 that is suitably rigid to reduce the force transmitted to the intermediate cable 440.

In the configuration illustrated in FIGS. 8A-8C, a first end of a coaxial cable can be connected to the second connector 445, and a second end of the coaxial cable can be connected to an associated image processing module 300 (e.g., mounted to the longitudinal member 640, or a component of the harvester external to the robot 600, as shown in FIGS. 6 and 7) such that the stereo imaging system can be operated through motion of the robot 600 without risking damage to the stereo imaging module 400 or the components thereof.

### Implementing Systems and Terminology

Implementations disclosed herein provide systems, methods, and devices for stereo imaging. One skilled in the art will recognize that these embodiments may be implemented in hardware or a combination of hardware and software and/or firmware.

Embodiments of stereo imaging systems according to the present disclosure may include one or more sensors (for example, image sensors), one or more signal processors (for example, image signal processors), and a memory including instructions or modules for carrying out the processes discussed above. The systems may also have data, a processor loading instructions and/or data from memory, one or more communication interfaces, one or more input devices, one or more output devices such as a display device and a power source/interface. The device may additionally include a transmitter and a receiver. The transmitter and receiver may be jointly referred to as a transceiver. The transceiver may be coupled to one or more antennas for transmitting and/or receiving wireless signals.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Further, the term “comprising” as used herein is synonymous with “including,” “containing,” or “characterized by,” and is inclusive or open-ended and does not exclude additional, unrecited elements or method steps. Accordingly, the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

it should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The above description discloses several systems and devices of the present disclosure. Embodiments of the present disclosure are susceptible to modifications in the methods and materials, as well as alterations in the fabrication methods and equipment. Such modifications will become apparent to those skilled in the art from a consideration of this disclosure or practice of the present disclosure. Consequently, it is not intended that the present disclosure be limited to the specific embodiments disclosed herein, but that it cover all modifications and alternatives coming within the true scope and spirit of the present disclosure as embodied in the attached claims.

1. A stereo imaging system comprising:
a stereo imaging module comprising:
a plurality of image sensors positioned to capture images of at least partially overlapping fields of view; and
processing circuitry configured to transmit the captured images via a coaxial cable connected to the stereo imaging module; and
a processing module configured to receive the captured images from the stereo imaging module via the coaxial cable, the processing module comprising:
processing circuitry configured to receive and process the captured images; and
power circuitry configured to provide electrical power to the stereo imaging module via the coaxial cable.

2. The stereo imaging system of claim 1, wherein the plurality of image sensors are color image sensors.

3. The stereo imaging system of claim 2, wherein the image processing module is configured to generate a depth mapping at least a portion of the partially overlapping fields of view based at least in part on color images captured by the color image sensors.

4. The stereo imaging system of claim 3, wherein the image processing module is further configured to generate one or more greyscale images based on the color images, the depth mapping generated based at least in part on the one or more greyscale images.

5. The stereo imaging system of claim 1, wherein the processing circuitry of the processing module is further configured to transmit to the stereo imaging module, via the coaxial cable, a timing signal that causes the plurality of image sensors to capture images simultaneously.

6. The stereo imaging system of claim 5, wherein the timing signal is a repetitive time-varying signal that causes the plurality of image sensors to capture a series of time-synchronized images.

7. The stereo imaging system of claim 5, further comprising at least a second stereo imaging module connected to the processing module by a second coaxial cable, the second stereo imaging module comprising a second plurality of image sensors, wherein the processing circuitry of the processing module is configured to simultaneously transmit the timing signal via the coaxial cable and the second coaxial cable such that the plurality of image sensors and the second plurality of images sensors capture images simultaneously.

8. The stereo imaging system of claim 1, wherein the stereo imaging module is mounted to a mechanical component configured to move relative to the processing module, and wherein a stereo imaging module end of the coaxial cable is coupled to a coaxial connector fixed to the mechanical component, the coaxial connector flexibly connected to the processing circuitry of the stereo imaging module such that forces applied from the coaxial cable to the coaxial connector are not transferred to the processing circuitry of the stereo imaging module or to the plurality of image sensors.

9. The stereo imaging system of claim 8, wherein the mechanical component comprises an end effector of a picking device.

10. The stereo imaging system of claim 9, wherein the processing module is connected by a second coaxial cable to a second stereo imaging module.

11. The stereo imaging system of claim 10, wherein the second stereo imaging module is mounted to a second end effector or a stationary component of the picking device.

12. The stereo imaging system of claim 10, wherein the picking device is a mobile picking device, and wherein the second stereo imaging module is fixed relative to a chassis of the mobile picking device.

13. The stereo imaging system of claim 1, wherein the stereo imaging module further comprises:
a temperature sensor configured to determine a temperature of the stereo imaging module; and
a heating element in communication with the temperature sensor and configured to activate when the temperature sensor detects a temperature lower than a predetermined threshold.

14. The stereo imaging system of claim 1, wherein the plurality of image sensors are spaced apart by a baseline distance of at least 5 mm and not greater than 50 mm.

15. The stereo imaging system of claim 14, wherein the plurality of image sensors are spaced apart by a baseline distance of at least 15 mm and not greater than 30 mm.

16. The stereo imaging system of claim 15, wherein the plurality of image sensors are spaced apart by a baseline distance of at least 20 mm and not greater than 25 mm.

17. The stereo imaging system of claim 1, wherein the stereo imaging module has a weight of less than 100 g.

18. The stereo imaging system of claim 1, wherein the processing circuitry of the stereo imaging module comprises a serializer configured to transmit the captured images to a deserializer of the image processing module via the coaxial cable.

19. The stereo imaging system of claim 1, wherein the processing circuitry of the stereo imaging module is further configured to combine pairs of individual images captured at the same time by the plurality of image sensors prior to transmission to the image processing module.

20. The stereo imaging system of claim 1, wherein the stereo imaging module is mounted to an end effector of a picking device, wherein the plurality of image sensors are spaced apart by a baseline distance of at least 20 mm and not greater than 25 mm, and wherein the stereo imaging module has a weight of less than 100 g.
